(19) United States
(12) Patent Application Publication
(10) Pub. No.: US 2007/0061325 A1
(43) Pub. Date: Mar. 15, 2007

(54) File managing apparatus and file managing method

(75) Inventor: Katsuhiko Akita, Amagasaki-shi (JP)

Correspondence Address: MORRISON & FOERSTER LLP, 1650 TYSONS BOULEVARD, SUITE 300, MCLEAN, VA, 22102, US

(73) Assignee: Konica Minolta Business Technologies, Inc., Tokyo (JP)

(21) Appl. No.: 11/326,376

(22) Filed: Jan. 6, 2006

(30) Foreign Application Priority Data
Sep. 9, 2005 (JP) 2005-261525

(51) Int. Cl. G06F 17/30

(52) U.S. Cl. 707/9

(57) ABSTRACT

A file managing apparatus includes user registration authority transfer unit of transferring user registration authority from a user holding the user registration authority that is authority to register a user having permitted file operation authority, notification unit of notifying the user registration authority to a first user, and user registering unit of registering a second user as a user having permitted file operation authority when accepting information on the second user from the first user.

This application is based on Japanese Patent Application No. 2005-261525 filed in Japan on Sep. 9, 2005, the contents of which are hereby incorporated by reference.

### BACKGROUND OF THE INVENTION

1. Field of the Invention

The invention relates to a file managing apparatus managing new registration of a user permitting a file operation.

2. Description of the Background Art

Conventionally, in a case where a limitation is imposed on user's operation authority for handling a file stored in a server, a multi-functional peripheral (MFP) or the like that have a file managing function, a file registrar registers a user permitting an operation of the file and notifies that to a registered user.

There has been available a technique, as a conventional art, that in a case where a user make an access to a folder to which the user has no access right to the folder including a file, an inquiry is made to a user having an access right to the folder and the former user's access is admitted only when permission is given as shown in Japanese Patent Laid-open Publication No. 2003-30028.

In the conventional technique, however, in a case where a new access right is permitted to a user having no access right to the region, an inquiry is made to another user who is permitted to make an access to the region but is not a registered user to the file, and an access right is also permitted if the access is accepted. Hence, the access right is not necessarily accepted to the registered user having the access right to a file located in the region, and a case can be arise where a user other than the registered user having the access right to the region permits the access to a third user altogether not connected to the file. If such a case arose, orderly management on an access to a file is impossible to be realized.

On the other hand, if groups in which plural users are included and file information is shared by the users, a file registrar is difficult grasping a user requiring file information in a detailed manner, which makes it necessary to perform user registration processing each time a user registration is requested, causing a load on a file registrar to be large.

### SUMMARY OF THE INVENTION

It is an object of the invention to provide a file managing apparatus capable of alleviating a load on a file registrar while performing an orderly management on a file access in registration of a new user to be permitted a file operation.

A file managing apparatus related to the invention includes:
user registration authority transfer unit of transferring user registration authority from a user holding the user registration authority that is authority to register a user having permitted file operation authority;
notification unit of notifying the user registration authority to a first user; and
user registering unit of registering a second user as a user having permitted file operation authority when accepting information on the second user from the first user.

The user registration authority transferring unit may be to transfer a user registration key.

The user registration authority transferring unit may be to use a combination of a file information managing table and user registration authority notification.

The file managing apparatus may further include management unit of managing related information relating the file to the user registration authority. The related information is, for example, a file information managing table.

The related information may include a registration effective term in which a user is newly registered, and that is related to the user registration authority. Alternatively, the related information may include the number of users to be registerable who resisters a user newly, that is related to the user registration authority. The related information may include registerable generations who registers a user newly and that is related to the user registration authority. The related information may further include file operation authority related to the user registration authority.

The management unit may alter the file operation authority on the related information according to a command of the first user.

The file managing apparatus may further include file registering unit of registering a file. Note that file registering unit may be installed on a site other than the file managing apparatus.

The file managing apparatus may further include file registrar notification unit of notifying to a file registrar having registered the file in a case where the first user has registered the second user.

A file managing method related to the invention includes:
transferring a user registration authority that is authority to register a user to whom file operation authority has been permitted from a user who can perform file registration;
notifying the user registration authority to the first user; and
registering a second user, in a case where information on the second user has been accepted from the first user, as a user having permitted file operation authority.

A user registration key indicating authority to register a user may be generated and notified to the first user, so that the user registration authority is transferred to the first user.

User registration authority notification indicating authority to register a user may be generated and notified to the first user, so that the user registration authority is transferred to the first user.

The file managing method may further include managing related information relating the file to the user registration authority.

Note that the related information may include a registration effective term in which a user is newly registered and that is related to the user registration authority. The related information may include the number of users to be registerable who registers newly, and that is related to the user registration authority. The related information may include registerable generations who registers a user newly, and that is related to the user registration authority. The related information may further include file operation authority related to the user registration authority, and that is related to the user registration authority.

The file managing method may also further include altering the file operation authority on the related information according to a command of the first user.

The file managing method may further include registering a file.

The file managing method may further include notifying to a file registrar having registered the file in a case the first user has registered the second user.

Note that the file managing method may be constructed as a file managing program executed on a computer. The file managing program may be stored on a computer readable recording medium.

According to a file managing apparatus related to the invention, since a user to whom authority to permit an access to a file has been transferred from a user who can perform file registration permits an access right to a file to another user, not only can an orderly management on access to a file be performed, but a load on a file registrar can also be alleviated.

### BRIEF DESCRIPTION OF THE DRAWINGS

The present invention will become readily understood from the following description of preferred embodiments thereof made with reference to the accompanying drawings, in which like parts are designated by like reference numeral and in which:

FIG. 1 is a schematic diagram showing a network construction including a file managing apparatus related to a first embodiment of the invention;

FIG. 2 is a block diagram showing a physical construction of the file managing apparatus related to a first embodiment of the invention;

FIG. 3 is a block diagram showing a functional construction of the file managing apparatus related to a first embodiment of the invention;

FIG. 4 is a flowchart for user registration by a file manager in a file managing method related to the first embodiment of the invention;

FIG. 5 is a flowchart for new user registration by a registered user in a file managing method related to the first embodiment of the invention;

FIG. 6 is a flowchart for a file managing method related to a second embodiment of the invention;

FIG. 7 is a flowchart for a file managing method related to a third embodiment of the invention;

FIG. 8 is a flowchart for a file managing method related to a fourth embodiment of the invention;

FIG. 9 is an example of file information managing table in a file managing method related to the fourth embodiment of the invention;

FIG. 10 is a flowchart for a file managing method related to a fifth embodiment of the invention;

FIG. 11 is a flowchart for a file managing method related to a sixth embodiment of the invention;

FIG. 12 is a block diagram showing a functional construction of a file managing apparatus related to a seventh embodiment of the invention;

FIG. 13 is a flowchart for user registration by a file manager in a file managing method related to the seventh embodiment of the invention; and

FIG. 14 is a flowchart for new user registration by a registered user in the file managing method related to the seventh embodiment of the invention.

### DESCRIPTION OF THE PREFERRED EMBODIMENTS

Description will be given of a file managing apparatus related to an embodiment of the invention with the reference to the accompanying drawings. Note that in the figures, the same constituents are attached with the same symbols.

First Embodiment

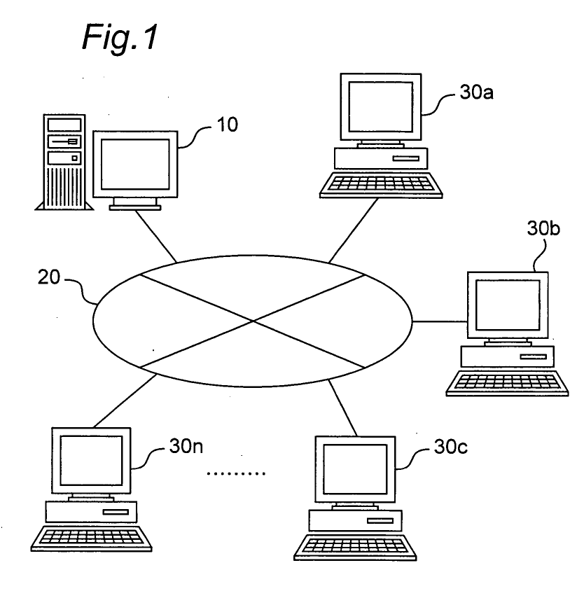

FIG. 1 is a schematic diagram showing a network construction including a file managing apparatus 10 related to a first embodiment of the invention. The file managing apparatus 10 is connected to user's terminals 30a, 30b, 30c, 30d, . . . 30n through a network 20. The file managing apparatus 10 is, for example, a server, MFP or the like, but is not limited to them and one of the terminals may be a file managing apparatus.

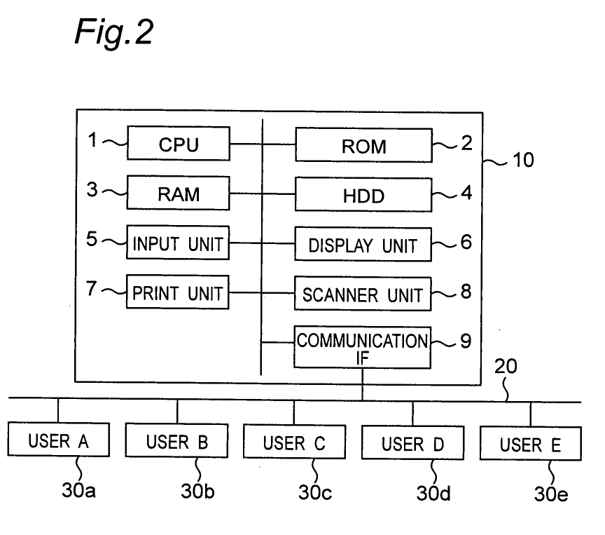

FIG. 2 is a block diagram showing a physical construction of the file managing apparatus 10 related to a first embodiment of the invention. The file managing apparatus 10 includes: CPU1, ROM2, RAM3, HDD4, a input unit 5, a display unit 6; a printing unit 7, a scanner unit 8 and a communication IF (interface) 9.

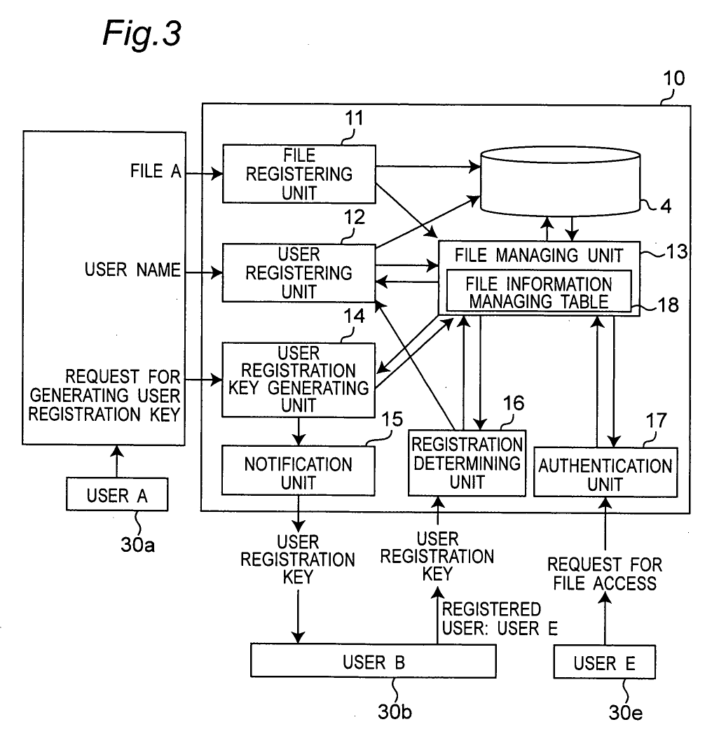

FIG. 3 is a block diagram showing a functional construction of the file managing apparatus 10 related to a first embodiment of the invention. The file managing apparatus 10 includes: a file registering unit 11; a user registering unit 12; a file managing unit 13; a user registration key generating unit 14; a notification unit 15; a registration determining unit 16 and an authentication unit 17. In the file registering unit 11, registration of a file A inputted from a user A (30a), who is a file registrar, is accepted and not only is the file A stored into HDD4, but information on the file A is also transmitted to the file managing unit 13. In the user registering unit 12, registration of information on a new user is accepted from the file registrar or a registered user having a user registration key and the information on a new user is transmitted to the file managing unit 13. In the file managing unit 13, a file information table 18 that is related information relating a file and a registered user to each other is managed on generation and updating thereof, registration of a new user permitted on operation of a file is managed based on the table 18. The user registration key generating unit 14 generates a user registration key indicating new user registration authority according to a request for generating user registration key from the user A. The notification unit 15 notifies the generated user registration key to a registered user (a user B (30b) in FIG. 3). In the registration determining unit 16, it is determined whether or not new user registration by a registered user is permitted with reference to the file information managing table 18. The authentication unit 17 performs, in case where a request for a file access is filed from a user, user authentication is performed with reference to the file managing table 18 to thereby determine whether or not the user is a user who have been permitted on file operation.

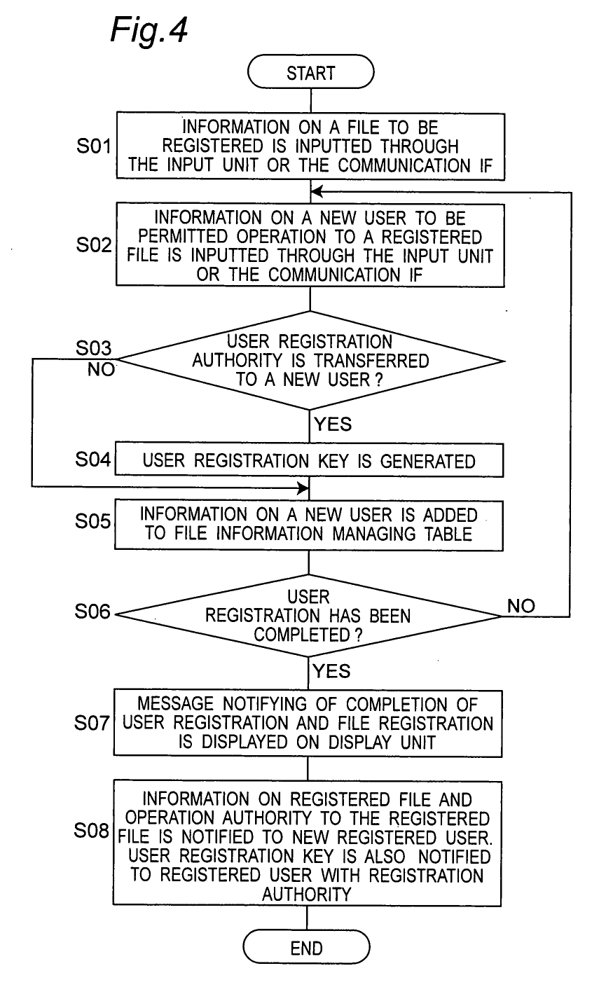

FIG. 4 is a flowchart for first user registration by a file manager in a file managing method related to the first embodiment.

(a) A user A (30a), who is a file registrar, inputs information on a file to be registered through the input unit 5 or the communication IF 9 (S01).

(b) Inputted is information on a new user who permits operation to a registered file through the input unit 5 or the communication IF 9 (S02).

(c) It is determined whether or not user registration authority is transferred to a new user according to the presence of absence of a request for generating a user registration key from a user A (S03). If the registration authority is transferred, the process advances to the next step S04, while the registration authority is not transferred, the process advances to step S05.

(d) A user registration key indicating registration authority is generated (S04). Note that plural kinds of user registration keys may be prepared in advance and related to plural kinds of registration authorities.

(e) Information on a new user is added to the file information managing table 18. (S05). Note that the file information managing table 18 may be kept in the file managing unit 13, but instead may be stored in HDD4, RAM3 or other recording media.

(f) It is determined whether or not user registration has been completed (S06). If the user registration has been completed, the process advances to the next step S07, while if the user registration has not been completed, the process returns to step S02.

(g) Completion of file registration and user registration is presented on the display unit 6 (S07).

(h) Information on a registered file and operation authority to the registered file is notified to a new registered user. Note that a user registration key is also notified to a registered user with registration authority (S08).

With all the steps completed, a first user registration by a file registrar (user A) is completed.

The above procedure prepares a file information managing table as shown in Table 1. For example, in the file information managing table as shown in Table 1 below, a file registrar for a file A is the user A, and a user B, a user C and a user D are registered by the user A as users having authority to operate a file A. Of the registered users, authorities to register a new user are transferred to the user B and the user C, to whom user registration keys “abcdefg” indicating registration authority are assigned. Since a registration key is not transferred to the user D, a user registration key is not set.

TABLE 1

| File | | | |
|---|---|---|---|
| Name | File Registrar | Registered User Name | User Registration Key |
| File A | User A | User B | abcdefg |
| | | User C | abcdefg |
| | | User D | None |

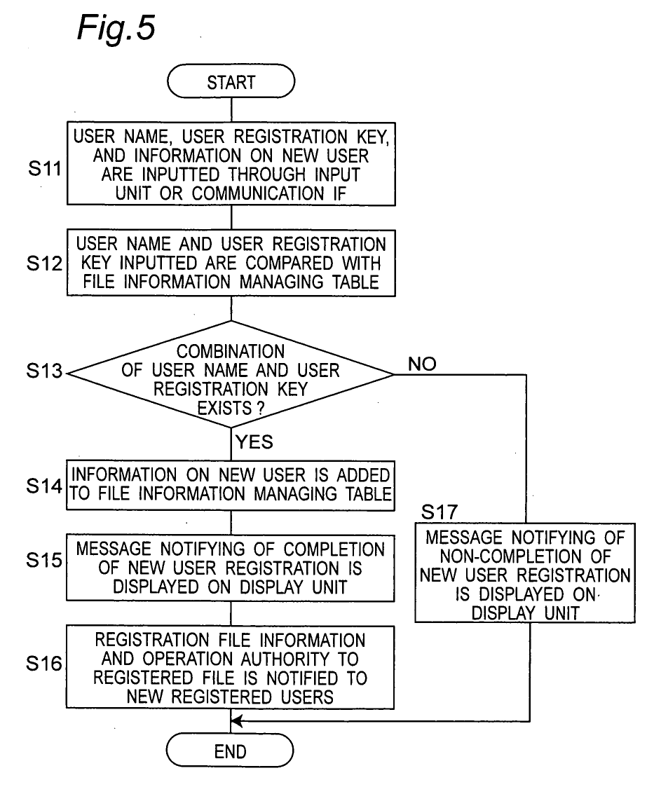

Then, description will be given of registration of a new user using a user registration key indicating registration authority by a registered user, who is not a file registrar in the file managing method. FIG. 5 is a flowchart for new user registration by a registered user, who is not a file registrar in a file managing method related to the first embodiment.

(a) A registered user other than a file registrar (the user B (30b) in FIG. 3) inputs information on a user name, a user registration key and a new user (a user E (30e) in FIG. 5) through the input unit 5 or the communication IF 9 (S11).

(b) The user name and the user registration key inputted are compared with the file information managing table 18 (A12).

(c) It is determined whether or not a combination of the user name and the user registration key is present in the file information managing table 18 (S13). If the combination is present, the process advances to the next step S14, while the combination is not present, it is presented on the display unit 6 that new user registration is disabled (S17) and the step ends.

(d) Information on a new user is added to the file information managing table 18 (S14). For example, in a file information managing table 18 shown below as Table 2, a user B having transferred registration authority registers a user E, a user F and a user G newly. The user (C) having transferred registration authority registers a user H newly.

(e) Completion of new user registration is presented on the display unit 6 (S15).

(f) Registration file information and operation authority to a registered file are notified to the new registered users (users E, F, G and H) (S16).

With all the steps completed, the registered users (users B and C) who are not file registrars registers new users using a user registration key.

TABLE 2

| | | | | Newly |
|---|---|---|---|---|
| File | File | Registered User | User Registration | Registered |
| Name | Registrar | Name | Key | User Name |
| File A | User A | User B | abcdefg | User E |
| | | | | User F |
| | | | | User G |
| | | User C | abcdefg | User H |
| | | User D | — | — |

Note that in Table 2, a parent user who has been registered is stated on the left side of the table and registered child users are stated on the right side directly thereof. That is, the user A who is a file registrar is a parent user at the highest order. The user B, the user C and the user D are registered as child users by the user A and the user H is registered as a grandchild by the user C.

In a file information managing table of Table 3 below, contents thereof are similar to those in Table 2 and there are shown whether or not there is a user registration key indicating a registration authority that can further register a new user and a parent user having registered users.

TABLE 3

| File | File | Registered User | User Registration | Parent User |
|---|---|---|---|---|
| Name | Registrar | Name | Key | Name |
| File A | User A | User B | abcdefg | User A |
| | | User C | abcdefg | User A |
| | | User D | — | User A |
| | | User E | — | User B |
| | | User F | — | User B |
| | | User G | — | User B |
| | | User H | — | User C |

Second Embodiment

A file managing method related to the second embodiment of the invention is different from the file managing method related to the first embodiment in that, as shown in a file information managing table as Table 4 below, a file registration term for new registration is set in advance and user registration exceeding the file registration term is excluded. In Table 4, new user registration authorities are transferred to a user B and a user C, wherein the registration terms are set 10 days and 3 hr, respectively. With registration terms set in this way, new user registration by a registered user other than a file registrar can be limited. Note that in Table 4, user registration keys (bcdefgh and cdefghi) are related to the respective registration terms (10 days and 3 hr).

TABLE 4

| | | | | User | |
|---|---|---|---|---|---|
| File | File | Registered User | User Registration | Registration | |
| Name | Registrar | Name | Key | Term | |
| File B | User A | User B | bcdefgh | 10 | days |
| | | User C | cdefghi | 3 | hours. |

| | | |
|---|---|---|
| User D | — | — |

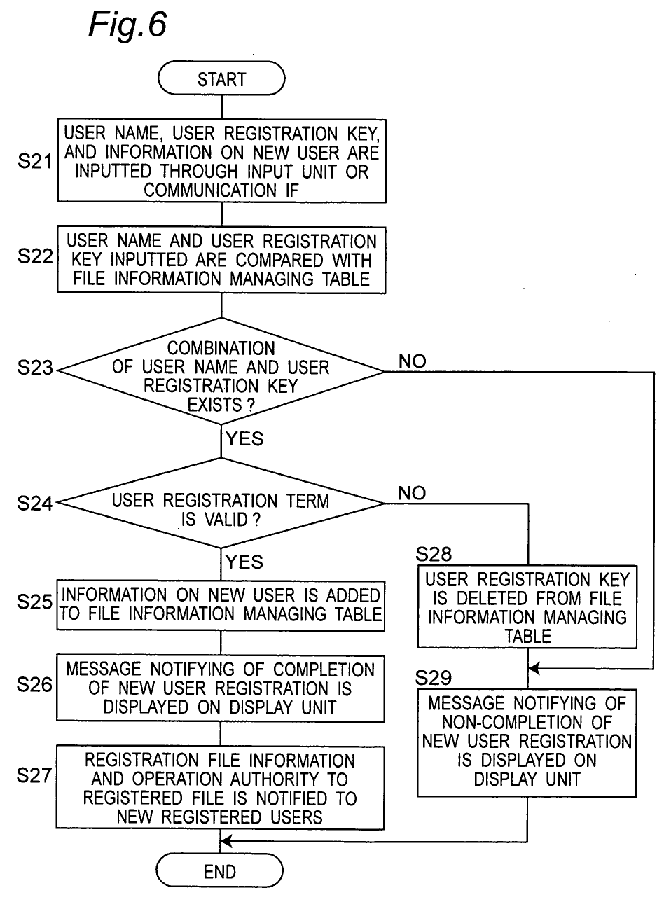

FIG. 6 is a flowchart for a file managing method related to a second embodiment of the invention.

(a) A registered user who is not a file registrar inputs a user name, a user registration key, and information on a new user (S21).

(b) The user name and the user registration key inputted are compared with the file information managing table 18 (S22).

(c) It is determined whether or not a combination of the user name and the user registration key is present in the file information managing table 18 (S23). If the combination is present, the process advances to the next step S24, while if the combination is not present, it is presented on the display unit 6 that new user registration is disabled (S29).

(d) It is determined whether or not the user registration term is valid (S24). If the registration term is valid, the process advances to the next step S25, while if the registration term is overdue, the user registration key is deleted from the file information managing table (S28) and thereafter, it is presented on the display unit 6 that new user registration is disabled (S29) and the step ends.

(e) Information on a new user is added to the file information managing table 18 (S25).

(f) It is presented on the display unit 6 that new user registration has been completed (S26).

(g) New file information and authority to operate a registered file are notified to a new registered user (S27).

With all the steps completed, the registered users (users B and C) who are not a file registrar register the new users using a user registration key in the registration term.

Third Embodiment

A file information managing method according to a third embodiment of the invention is different from the file managing methods related to the first and second embodiments in that, as shown in a file information managing information of Table 5 below, the number of users to be registerable in new registration of users is set in advance and user registration that exceeds the number of user to be registerable is excluded. In Table 5, registration authorities to new users are transferred to the user B and the user D, wherein the number of users to be registerable is set to 10 users and 2 users, respectively. With the number of users to be registerable set in advance, registration of new users by a registered user other than the file registrar can be limited. Not that in Table 5, user registration keys are related to the number of users to be registerable.

TABLE 5

| | File | | User | No. of Users |
|---|---|---|---|---|
| File Name | Registrar | User Name | Registration Key | Registerable |
| File C | User A | User B | defghij | 10 |
| | | User C | — | — |
| | | User D | efghijk | 2 |

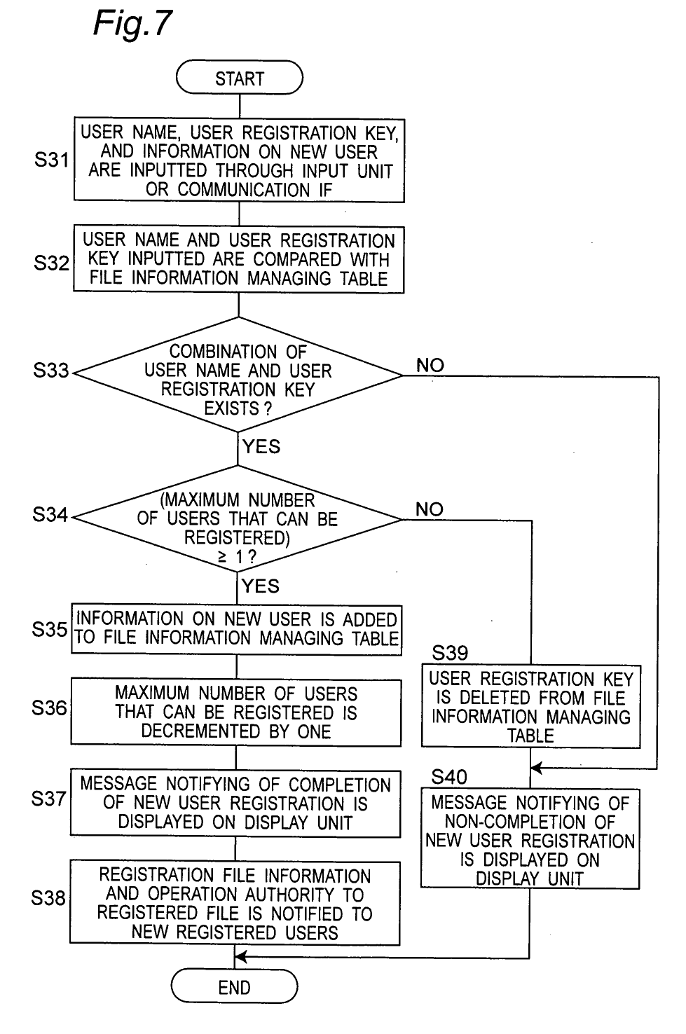

FIG. 7 is a flowchart for a file managing method related to a third embodiment of the invention.

(a) A registered user who is not a file registrar inputs a user name, a user registration key, and information on a new user through the input unit 5 and the communication IF 9 (S31).

(b) The user name and the user registration key inputted are compared with the file information managing table 18 (S32).

(c) It is determined whether or not a combination of the user name and the user registration key is present in the file information managing table 18 (S33). If the combination is present, the process advances to the next step S34, while if the combination is not present, it is presented on the display unit 6 that new user registration is disabled (S40) and the step ends.

(d) Then, it is determined whether or not there are one or more users can be registered with reference to the file information managing table 18 (S34). If one or more users are registerable, the process advances to the next step S35., while no user is registerable, a user registration key is deleted from the file information managing table 18 (S39) and thereafter, it is presented on the display unit 6 that new user registration is disabled (S40) and the step ends.

(e) Information on a new user is added to the file information managing table 18 (S35).

(f) The number of users to be registerable is decremented by one in the file information managing table 18 (S36).

(g) It is presented on the display unit 6 that new user registration has been completed (S37).

(h) Registered file information and authority to operate a registered file are notified to the new registered user (S38).

With all the steps completed, the registered users (users B and D) who are not file registrars can register new users using user registration keys within the number of users to be registerable.

Fourth Embodiment

A file managing method related to the fourth embodiment of the invention is different from the file information managing methods related to from the first to third embodiments in that, as shown in a file information managing table of Table 6 below, registerable generations for new registration of users are set in advance and user registration exceeding the registerable generations is excluded. In Table 6, registration authorities to new users are transferred to a user B and a user C and three generations and one generation are set as registerable generations or generation. With registerable generations or generation set, new user registration by a registered user other than a file registrar is limited. Note that in Table 6, user registration keys are related to respective registerable generations.

TABLE 6

| | | | | No. of |
|---|---|---|---|---|
| | File | | User | Generations |
| File Name | Registrar | User Name | Registration Key | Registerable |
| File D | User A | User B | defghij | 3 |
| | | User C | hijklmn | 1 |
| | | User D | — | — |
| | | User E | — | — |

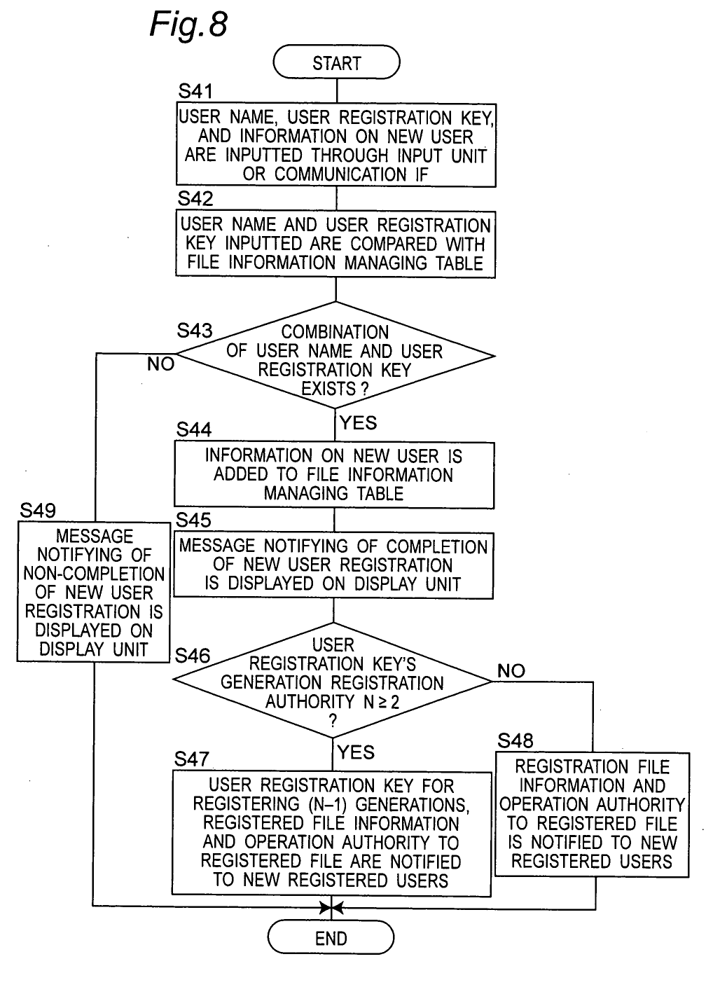

FIG. 8 is a flowchart for the file managing method.

(a) A registered user who is not a file registrar inputs a user name, a user registration key and a new user information through the input unit 5 and the communication IF9 (S41).

(b) The user name and the user registration key inputted are compared with the file information managing table 18 (S42).

(c) It is determined whether or not a combination of the user name and the user registration key is present in the file information managing table 18 (S43). If the combination is present, the process advances to the next step S44, while the combination is not present, it is presented on the display unit 6 that new user registration is disabled (S49).

(d) Information on a new user is added to the file information managing table 18 (S44).

(e) It is presented on the display unit 6 that new user registration has been completed (S45).

(f) It is determined whether or not two or more registerable generations n are related to user registration keys (S46). If there are 2 or more registerable generations n, the process advances to step S47, while if there is one registerable generation n, the process advances to step S48.

(g) User registration keys of registerable generations n−1, registered file information and authority to operate a registered file are notified to a new registered user (S47). In this case, since there are two or more registerable generations n, registration authorities less by one generation are transferred to the registered user.

(h) Registered file information and authority to operate a registered file are notified to a new registered user (S48). In this case, since a parent user has one user registerable generation n, no registration authority is transferred.

With all the steps completed, a registered user who is not a file registrar can register new users using user registration keys within the user registerable generations.

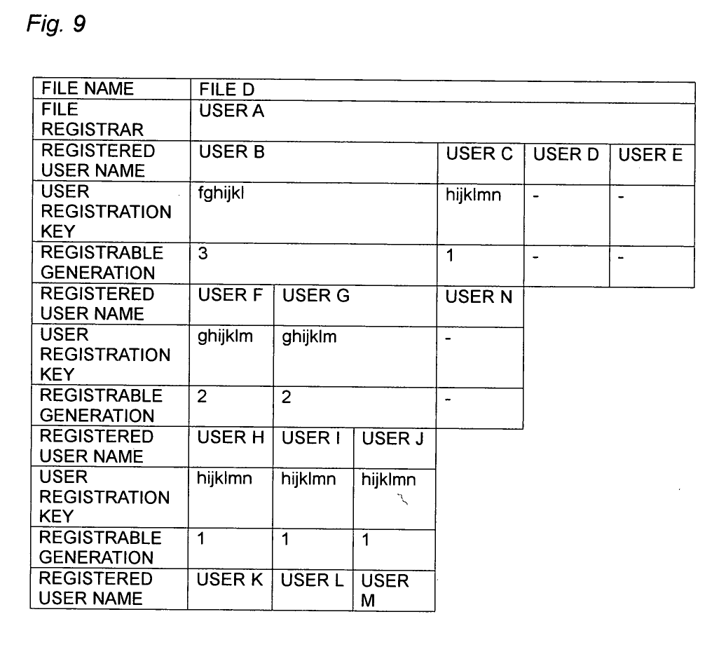

FIG. 9 is an example of file information managing table after a registered user having registration authorities over plural generations registers a new user and the registered user further registers a new user and updates the file information managing table based on the file information managing table of Table 6. In FIG. 9, a user shown on the left side is a user shown on the right side directly next thereto is a child user. The following are understood from FIG. 9. That is, a user A who is a file registrar registers users B. C. D and E. The user B having three registerable generations registers users F and G who have two registerable generations. The user C having one registerable generation having no transferred registration authority registers a user N having only file operation authority. Besides, the user F having two registerable generations registers the user H having one registerable generation. The user G registers users I and J. The user H having one registerable generation has no transferred registration authority, and registers a user K having only file operation authority, and the user I registers a user L similarly and the user J registers a user M. Note that FIG. 9 shows parent users and child users so as to be visually recognizable, while the file information managing table is not limited to the case of FIG. 9. For example, a file information managing table of Table 7 described below may be replaced for FIG. 9. In Table 7, there are shown, in a similar way to that in Table 3, a registered names, user registration keys, registerable generations and parent user name. In Table 7, since only a parent user for each registered user is shown, the file information managing table is easily managed.

TABLE 7

| | | | User | No. of | Parent |
|---|---|---|---|---|---|
| File | File | Registered | Registration | Generations | User |
| Name | Registrar | User Name | Key | Registerable | Name |
| File D | User A | User B | defghij | 3 | User A |
| | | User C | hijklmn | 1 | User A |
| | | User D | — | — | User A |
| | | User E | — | — | User A |
| | | User F | ghijkim | 2 | User B |
| | | User G | ghijkim | 2 | User B |
| | | User H | hijklmn | 1 | User F |
| | | User I | hijklmn | 1 | User G |
| | | User J | hijklmn | 1 | User G |
| | | User K | — | — | User H |
| | | User L | — | — | User I |
| | | User M | — | — | User J |
| | | User N | — | — | User C |

Fifth Embodiment

A file managing method related to the fifth embodiment of the invention is different from the file managing method related to the first embodiment in that in a case where a new user other than a file registrar has been registered, the information is notified to the file registrar. In a file managing method of the invention, since a registered user having a user registration key indicating registration authority other than the user registrar can register a new user, information on a new user registered in the case is notified to the file registrar to thereby, the file registrar can grasp information on all the registered users.

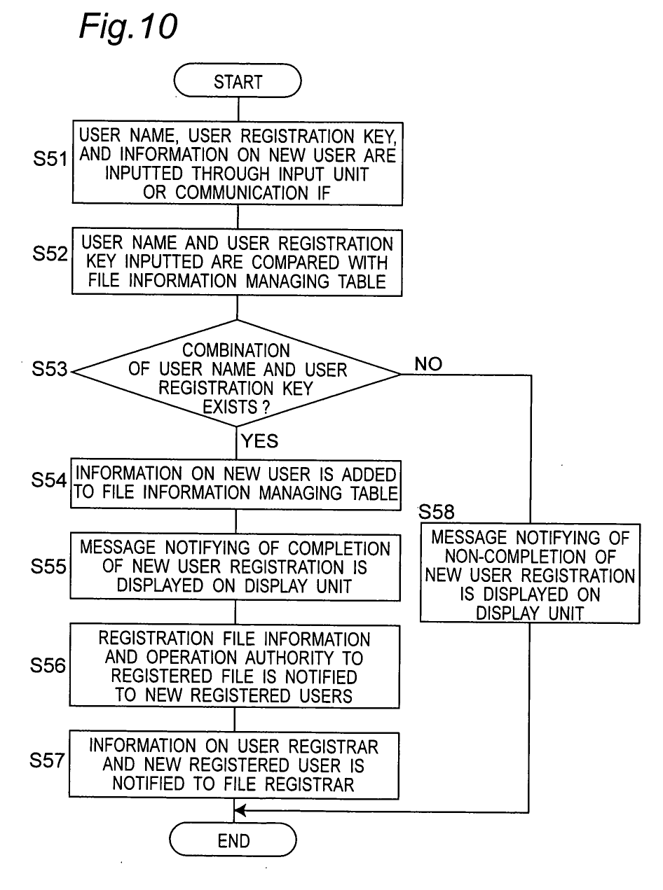

FIG. 10 is a flowchart for a file managing method related to the fifth embodiment of the invention.

(a) A registered user other than the file registrar inputs a user name, a user registration key and information on a new user (S51).

(b) the user name and the user registration key inputted are compared with the file information managing table 18 (S52).

(c) It is determined whether or not a combination of the user name and the user registration key is present in the file information managing table 18 (S53). If the combination is present, the process advances to the next step S54, while if the combination is not present, it is presented on the display unit 6 that new user registration is disabled (S58).

(d) Information on the new user is added to the file information managing table 18 (S54).

(e) It is presented on the display unit 6 that new user registration has been completed (S55).

(f) Registration file information and authority to operate a registered file are notified to the newly registered user (S56).

(g) Information on a user registrar and the new registered user is notified to the file registrar (S57).

With all the steps completed, a registered user who is not a file registrar, in a case where registering a new user using a user registration key, can notifies information on the new user to the file registrar.

Sixth Embodiment

A file managing method related to the sixth embodiment of the invention is different from the file managing methods of from the first to fifth embodiments in that in the file information managing table, contents of plural kinds of file operation authorities as shown in Table 8 below are also related together with user registration keys indicating registration authorities of new users. The file managing method of the sixth embodiment is different in that a method for altering file operation authority is defined. By setting file operation authority of a new user, for example, an important file can be protecting by setting the authority only to reading (Read). By enabling file operation authority to be properly altered, security in file management can be improved.

TABLE 8

| Level | File Operation Authority |
|---|---|
| Level 2 | Read & Write |
| Level 1 | Read |

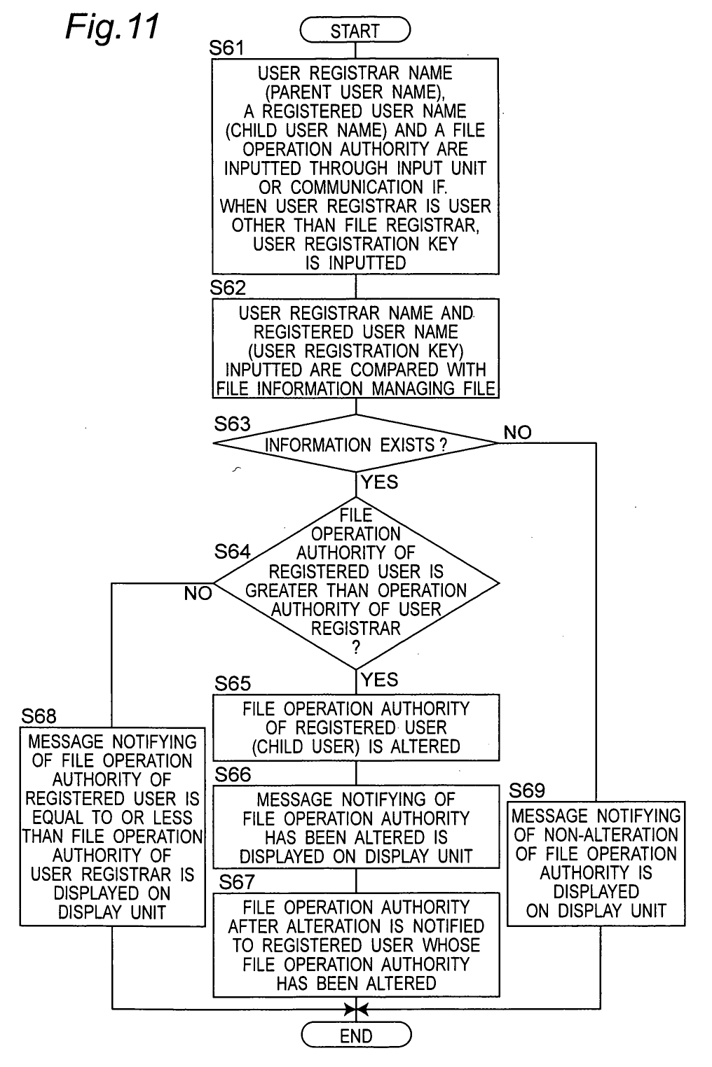

FIG. 11 is a flowchart for the file managing method.

(a) A registered user inputs a user registrar name (parent user name), a registered user name (child user name) and file operation authority through the input unit 5 or the communication IF 9. The user registrar, in a case where being a user other than a file registrar, inputs a user registration key (S61).

(b) The user registrar name and the registered user name (user registration key) inputted are compared with the file information managing file 18 (S62).

(c) It is determined whether or not the information is present (S63). If the information is present, the process advances to the next step S64, while if the information is not present, it is presented on the display unit that file operation authority alteration is disabled (S69) and the step ends.

(d) It is determined whether or not file operation authority of the registered user (child user) exceeds operation authority of the user registrar (parent user) (S64). If file operation authority of the child user exceeds file operation authority of the parent user, the process advances to the next step S65, while if file operation authority of the child user does not exceed, it is presented on the display unit that file operation authority of the registered user is equal to or less than file operation authority of the user registrar(S68), the step ends.

(e) File operation authority of the registered user (child user) is altered (S65). For example, in a case of a file information managing table of Table 9 below, file operation authorities of a user B and a user C are both set to “Read & Write”. In a case where file operation authority of the user B is altered from “Read & Write” to “Read”, the user C and a user D have the user B as a parent user and file operation authority of a registered user in a lower order is equal to or lower than file operation authority of the parent user. Hence, as shown in Table 10 below, file operation authority of not only the user B but also the user C are altered from “Read & Write” to “Read”.

(f) It is presented on the display unit 6 that file operation authority has been altered (S66).

(g) File operation authority after the alteration is notified to the registered user whose file operation authority has been altered (S67).

With all the steps completed, file operation authority of a child user can be altered so as to be adapted for file operation authority of a parent user. Thereby, only file operation authority of the parent user is altered to thereby enable file operation authority of child users can be collectively altered.

TABLE 9

| | | Registered | User | File | Parent |
|---|---|---|---|---|---|
| File | File | User | Registration | Operation | User |
| Name | Registrar | Name | Key | Authority | Name |
| File E | User A | User B | klmnopq | Read & Write | User A |
| | | User C | — | Read & Write | User B |
| | | User D | — | Read | User B |

TABLE 10

| | | Registered | User | File | |
|---|---|---|---|---|---|
| File | File | User | Registration | Operation | Parent User |
| Name | Registrar | Name | Key | Authority | Name |
| File E | User A | User B | klmnopq | Read | User A |
| | | User C | — | Read | User B |
| | | User D | — | Read | User B |

Note that in the above example alteration of file operation authority, only file operation authority is altered separately from a user registration key, while a user registration key and file operation authority may be, as shown in Table 11 below, altered being related to each other.

TABLE 11

| User Registration Key | File Operation Authority |
|---|---|
| ijklmno | Read & Write |
| jklmnop | Read |

Seventh Embodiment

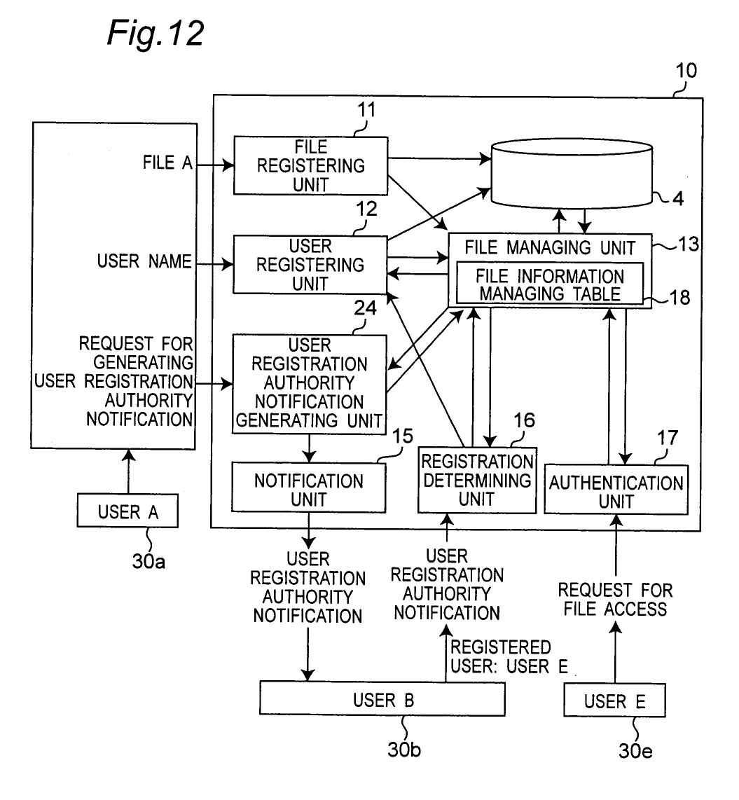

FIG. 12 is a block diagram showing a functional construction of a file managing apparatus 10a related to a seventh embodiment of the invention. The file managing apparatus 10a is different from the file managing apparatus related to the first embodiment in that not only is user registration authority notification employed instead of a user registration key indicating authority to register a user, but user registration authority notification generating unit 24 is also equipped instead of the user registration key generating apparatus 14. Note that since user registration authority notification is, as described above, employed instead of a user registration key, the user registering unit 12 accepts registration of new user information from a file registrar or a registered user having user registration authority notification, and transmits the new user information to the file managing unit 13. The user registration authority notification generating unit 24 generates user registration authority notification indicating registration authority of a new user according to a request for generating user registration authority notification from a user A. The notification unit 15 notifies the generated user registration authority notification to a registered user (user B (30b) in FIG. 12). The other operations are the same as those in constituents of the file managing apparatus related to the first embodiment.

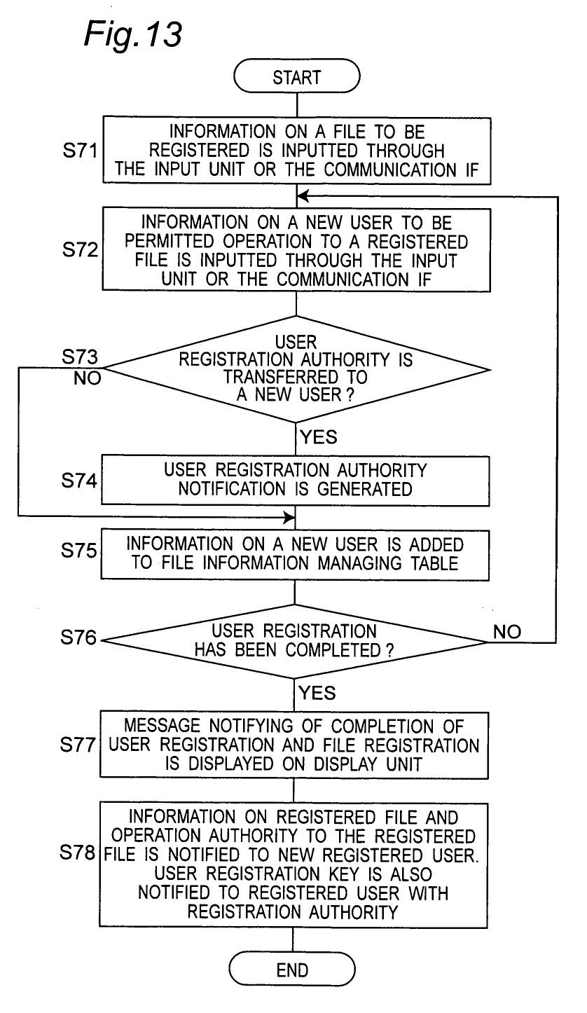

FIG. 13 is a flowchart for first user registration by a file registrar in a file managing method related to the seventh embodiment.

(a) A user A (30a) who is a file registrar inputs file information to be registered through the input unit 5 or the communication IF 9 (S71).

(b) Information on a new user to be permitted an operation to a registered file is inputted through the input unit 5 or the communication IF 9 (S72).

(c) It is determined whether or not user registration authority is transferred to a new user according to the presence or absence of a request for generating user registration authority notification from the user A (S73). If the registration authority is transferred, the process advances to the next step S74, while if the registration authority is not transferred, the process advances to step S75.

(d) User registration authority notification indicating registration authority is generated (S74). Note that plural kinds of user registration authority notifications are prepared, to which plural kinds of registration authority may be related. Detailed description will be given of this in another embodiment.

(e) Information on a new user is added to the file information managing table 18 (S75). Note that the file information managing table 18 may be kept in the file managing unit 13, but instead, may be kept in HDD4, RAM3 or other recording media.

(f) It is determined whether or not user registration has been completed (S76). If the user registration has been completed, the process advances to the next step S77, while if the user registration has not been completed, the process returns to step S72.

(g) It is presented on the display unit 6 that user registration has been completed (S77).

(h) Registered file information and authority to operate a registered file are notified to a new registered user. Note that user registration authority notification is also notified to a registered user having registration authority (S78).

With all the steps completed, first user registration by a file registrar (user A) 30a is completed.

A file information managing table as shown in Table 12 is prepared by the above procedure. For example, in the file information managing table shown in Table 12 below, a file registrar for a file A is a user A and a user B, a user C and a user D are registered as users having permitted authority to operate file A. Of the registered users, authority to register a new user is further transferred to the user B and the user C, and user registration authority notification “notification A” indicating registration authority is set to each the user B and the user C. Registration authority notice is not set to the user D since user registration authority is not transferred to the user D.

TABLE 12

| | | Registered User | User Registration |
|---|---|---|---|
| File Name | File Registrar | Names | Authority Notification |
| File A | User A | User B | Notification A |
| | | User C | Notification A |
| | | User D | None |

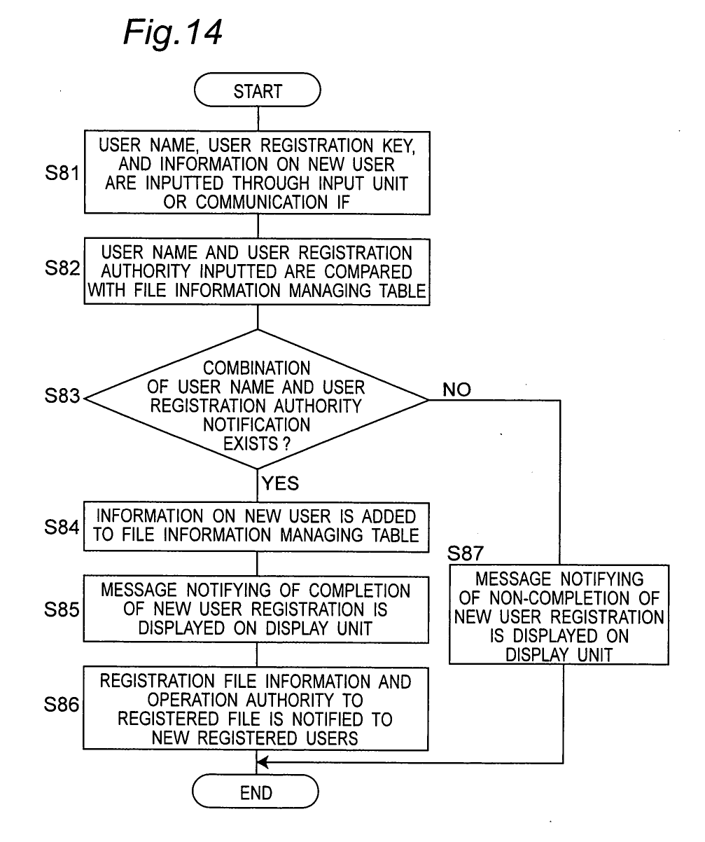

Next, description will be given of new user registration using user registration authority notification indicating registration authority by a registered user who is not a file registrar in the file managing method. FIG. 14 is a flowchart for new user registration by a registered user who is not a file registrar in the file managing method related to the seventh embodiment.

(a) A registered user who is not a file registrar (user B (30b) in FIG. 12) inputs a user name, user registration authority notification and information on a new user (user E (30e) in FIG. 14) through the input unit 5 or the communication IF 9 (S81).

(b) The user name and the user registration authority notification inputted are compared with the file information managing table 18 (S82).

(c) It is determined whether or not a combination of the user name and the user registration authority notification is present in the file information managing table 18 (S38). If the combination is present, the process advances to the next step S84, while if the combination is not present, it is presented on the display unit 6 that new user registration is disabled (S87) and the step ends.

(d) New user information is added to the file information managing table 18 (S84). For example, in a file information managing table 18 of Table 13 below, the user B having transferred registration authority registers a user E, a user F and a user G newly. The user C having transferred registration authority registers a user H newly.

(e) It is presented on the display unit 6 that new user registration has been completed (S85).

(f) Registered file information and authority to operate a registered file are notified to the new registered users E, F, G and H) (S86).

With all the steps completed, registered users (users B and C) who are not file registrars can register a new user using user registration authority notification.

TABLE 13

| | | | User Registration | Newly |
|---|---|---|---|---|
| File | File | Registered User | Authority | Registered |
| Name | Registrar | Names | Notification | User Name |
| File A | User A | User B | Notification A | User E |
| | | | | User F |
| | | | | User G |
| | | User C | Notification A | User H |
| | | User D | — | — |

Note that, in Table 13, a registered parent user is stated on the left side and registered child users are stated on the right side next thereto. That is, the user A who is a file registrar is a parent user at the highest order. The user A registers the user B, the user C and the user D as child users and the user B registers the user E, the user F and the user G as grandchildren, while the user C registers the user H as a grandchild.

On the other hand, in a file information managing table of Table 14 below, contents of which are similar to those of Table 13, there are shown whether or not user registration authority notification indicating registration authority that can further register a new user is possessed by each of the registered users and the parent users who have registered the registered users.

TABLE 14

| | | | User Registration | |
|---|---|---|---|---|
| File | File | Registered User | Authority | Parent User |
| Name | Registrar | Names | Notification | Name |
| File A | User A | User B | Notification A | User A |
| | | User C | Notification A | User A |
| | | User D | — | User A |
| | | User E | — | User B |
| | | User F | — | User B |
| | | User G | — | User B |
| | | User H | — | User C |

A file managing apparatus according to the present invention may be used as a file managing apparatus managing new registration of a user permitting a file operation.

Although the present invention has been described in connection with the preferred embodiments thereof with reference to the accompanying drawings, it is to be noted that various changes and modifications are apparent to those skilled in the art. Such changes and modifications are to be understood as included within the scope of the present invention as defined by the appended claims, unless they depart therefrom.

What is claimed is:

1. A file managing apparatus comprising:
user registration authority transfer unit of transferring user registration authority from a user holding the user registration authority that is authority to register a user having permitted file operation authority;
notification unit of notifying the user registration authority to a first user; and
user registering unit of registering a second user as a user having permitted file operation authority when accepting information on the second user from the first user.

2. The file managing apparatus according to claim 1, wherein the user registration authority transfer unit is to transfer a user registration key.

3. The file managing apparatus according to claim 1, wherein the user registration authority transferring unit is to use a combination of a file information managing table and user registration authority notification.

4. The file managing apparatus according to claim 1, further comprising management unit of managing related information relating the file to the user registration authority.

5. The file managing apparatus according to claim 4, wherein the related information includes a registration effective term in which a user is newly registered, and that is related to the user registration authority.

6. The file managing apparatus according to claim 4, wherein the related information includes the number of users to be registerable who resisters a user newly, that is related to the user registration authority.

7. The file managing apparatus according to claim 4, wherein the related information includes registerable generations who resisters a user newly registered and that is related to the user registration authority.

8. The file managing apparatus according to claim 4, wherein the related information includes file operation authority related to the user registration authority.

9. The file managing apparatus according to claim 8, wherein the management unit alters the file operation authority on the related information according to a command of the first user.

10. The file managing apparatus according to claim 1, further comprising file registering unit of registering a file.

11. The file managing apparatus according to claim 1, further comprising file registrar notification unit of notifying to a file registrar having registered the file in a case where the first user has registered the second user.

12. A file managing method comprising:
transferring user registration authority that is authority to register a user to whom file operation authority has been permitted from a user who can perform file registration;
notifying the user registration authority to the first user; and
registering a second user, in a case where information on the second user has been accepted from the first user, as a user having permitted file operation authority.

13. The file managing method according to claim 12, wherein a user registration key indicating authority to register a user is generated and notified to the first user, thereby the user registration authority is transferred to the first user.

14. The file managing method according to claim 12, wherein user registration authority notification indicating authority to register a user is generated and notified to the first user, thereby the user registration authority is transferred to the first user.

15. The file managing method according to claim 12, further comprising managing related information relating the file to the user registration authority.

16. The file managing method according to claim 15, wherein the related information includes a registration effective term in which a user is newly registered and that is related to the user registration authority.

17. The file managing method according to claim 15, wherein the related information includes the number of users to be registerable who register a user newly, and that is related to the user registration authority.

18. The file managing method according to claim 16, wherein the related information includes registerable generations who resisters a user newly, and that is related to the user registration authority.

19. The file managing method according to claim 15, wherein the related information includes file operation authority related to the user registration authority, and that is related to the user registration authority.

20. The file managing method according to claim 19, further comprising altering the file operation authority on the related information according to a command of the first user.

21. The file managing method according to claim 12, further comprising registering a file.

22. The file managing method according to claim 12, further comprising notifying to a file registrar having registered the file in a case where the first user has registered the second user.

23. A computer-readable recording medium which stores a file managing program for prompting a computer to execute a file managing method comprising:
transferring user registration authority that is authority to register a user to whom file operation authority has been permitted from a user who can perform file registration;
notifying the user registration authority to the first user; and
registering a second user, in a case where information on the second user has been accepted from the first user, as a user having permitted file operation authority.
